(19) United States
(12) Patent Application Publication
(10) Pub. No.: US 2005/0157749 A1
(43) Pub. Date: Jul. 21, 2005

(54) System and method for communication with an external network in an IPv6 MANET network

(75) Inventors: Soon-Jung Lee, Suwon-si (KR); In-Oh Chung, Suwon-si (KR); Jai-Dong Kim, Seoul (KR); Jai-Ho Lee, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/943,361

(22) Filed: Sep. 17, 2004

(30) Foreign Application Priority Data
Jan. 19, 2004 (KR) 4009-2004

(51) Int. Cl. H04Q 7/24; H04L 12/28

(52) U.S. Cl. 370/466; 370/338; 370/401

(57) ABSTRACT

Disclosed is a system for performing communication with an external network through an Internet gateway in a mobile ad-hoc (MANET) network including more than one node having a link local address, the system including a source node for setting a source address to the link local address, and transmitting packet data having a destination address of set to an address of the external network, to the Internet gateway; and the Internet gateway for changing a source address of the packet data to a global address corresponding to the link local address, and transmitting the global address to the external network, when the packet data having a destination of the external network, are received from the source node.

### PRIORITY

This application claims priority to an application entitled “System and Method for Communication with External Network in IPv6 MANET Network” filed in the Korean Intellectual Property Office on Jan. 19, 2004 and assigned Serial No. 2004-4009, the contents of which are hereby incorporated by reference.

### BACKGROUND OF THE INVENTION

1. Field of the Invention

The present invention relates to a system and a method for connecting to an external network in an IPv6 MANET network, and more particularly to a system and a method for effectively constructing a network by reducing network load for connecting to an external network in an IPv6 network.

2. Description of the Related Art

Generally, in order to connect to the Internet in an Internet protocol version 6 (IPv6) network, a mobile ad-hoc network (hereinafter, referred to as a MANET) node must receive information from an Internet gateway (IG) to generate the global address on the basis of the received information. The MANET node can transmit/receive data to/from the Internet by using the generated global address as described above. Currently, a method of efficiently connecting to the Internet in an IPv6 MANET network may be classified in two ways. According to the first, a predetermined field for route discovery is added to an on-demand routing protocol for finding an Internet gateway in the MANET network. According to the second, a route solicitation made by adding a predetermined field to a NDP (Neighbor Discovery Protocol) and an advertisement of the NDP are used. Hereinafter, a method will be described, which applies Internet connectivity to an Ad hoc On Demand Distance Vector (AODV) routing protocol having an on-demand mode from among MANET protocols. When a node in the IPv6-based MANET network is to be connected to the Internet, the node must receive information from the Internet gateway for generating the global address. Then, the node generates the global address on the basis of the received information and must use the generated global address. Accordingly, every time one node in the MANET network needs to communicate with the Internet, the node must find the Internet gateway in order to obtain its own global prefix information and the length of the information. Otherwise, a technology of finding the Internet gateway before the necessity of connecting to the Internet occurs and the existing technology of finding the Internet gateway in advance are required.

Hereinafter, a conventional process in which a source node connects to the Internet will be described with reference to FIGS. 1a to 1e. FIGS. 1a and 1e are views showing flow for connecting to an external network in the conventional IPv6 MANET network. First, as shown in FIG. 1a, the source node 100 transmits a route request (RREQ) to an Internet gateway 102 through intermediate nodes. Herein, the RREQ is used when the source node 100 requests prefix information of the Internet gateway 102 for generating a global address in order to be connected to the Internet. Then, the Internet gateway 102 transmits a route reply (RREP) to the source node 100 having transmitted the RREQ as shown in FIG. 1b. Herein, the transmitted RREP is a message including the prefix information of the Internet gateway 102 as a response of the RREQ. The source node 100 having received the RREP changes its own IPv6 address. That is, the address of the source node 100 changes from a link local address stored as shown in FIG. 1a to the global address including the prefix information of the Internet gateway 102 as shown in FIG. 1b. Then, since its own address information has changed, the source node 100 transmits as shown in FIG. 1c a route error (RERR) to peripheral nodes in a broadcast method. Each of the nodes having received the RERR removes a link local address contained in the received RERR from a routing table. Therefore, the peripheral nodes lose information for the node requesting the Internet connection. Accordingly, links between the node 100 and the peripheral nodes are broken as shown in FIG. 1d. Herein, in order to again form routes with the peripheral nodes for communication in the MANET network, a route discovery process must be performed as shown in FIG. 1e.

Then, a process in which the source node 100 exchanges a signal with the Internet gateway 102 for connecting to the Internet 104 will be described with reference to FIG. 2. FIG. 2 is a flow chart showing flow of signals between the source node 100 and the Internet gateway 102 for connecting to the Internet 104, which is an external network, in the conventional IPv6 network. Herein, a description will be given on assumption that the external network is the Internet 104.

First, the node 100 in the MANET network generates and stores the link local address in step 200. Then, in step 202, the node 100 transmits a RREQ control packet with respect to the external network to the Internet gateway 102 for connecting to the Internet 104. Then, the Internet gateway 102 reads its own address and global prefix information in step 204 and in step 206 transmits a RREP control packet for the RREQ to the node 100. The node 100 having received the RREP control packet generates a global address for allowing a routing with the Internet to be performed in step 208. Thereby, a route to the Internet gateway 102 is formed. In this way, when the node 100 generates the global address, the node 100 changes the link local address already stored in the node 100 to the newly generated global address.

Herein, since the address of the node 100 has changed, links between the node 100 and peripheral nodes are broken. Therefore, the peripheral nodes lose all route information that has already been formed. Accordingly, the node 100, which has requested for the global prefix to the Internet gateway 102 and changed its own address to the global address, broadcasts a RERR in step 210. Since the RERR includes the link local address having been used before, the peripheral nodes having received the RERR remove the link local address contained in the RERR from their own routing tables. Therefore, the peripheral nodes lose information for the node 100 requesting the Internet connection. That is, links between the node 100 and the nodes are released in step 212. The node 100 requesting the Internet connection becomes a new node to the peripheral nodes. Accordingly, in order to form routes to the peripheral nodes, the route discovery process must be performed.

As described above, the information required for generating the global address includes the IP address and the prefix of the Internet gateway 102. Herein, the prefix is used when a node generates an IPv6 address for routing with the Internet. When the node existing in the MANET network requests the global prefix information and the length of the prefix of the Internet gateway 102, the Internet gateway 102 must respond to the request. In an on-demand mode, such a procedure is performed by receiving the RREP as a response to the RREQ sent by the node. Further, an intermediate node between the source node 100 and the Internet gateway 102 cannot respond to the request sent by the source node 100. When there exist more than one Internet gateway and intermediate nodes responding to the request, the node having performed the request can obtain only information of an Internet gateway known to the intermediate nodes. The intermediate nodes lose information for the node 100 to be connected to the Internet, and recognize the node 100 as a new node. Accordingly, when a route path is to be set again, the source node 100 must perform an operation for route discovery. That is, an excessive number of the RRER, RREQ, and RREP, which are overhead control packets in a wireless network having a limited bandwidth and a mobile terminal having a limited resource, are unnecessarily sent, overloading the network. Further, since each of the peripheral nodes updates a routing table, a battery and processor resources are wasted.

As described above, the node in the MANET network changes the IPv6 address for connecting to the Internet, so that a heavy overhead occurs in nodes constituting the MANET network and therefore the MANET network. Therefore, many resources are unnecessarily wasted. Further, in the mobile terminal having the limited resources and the wireless network having the limited bandwidth, such a factor deteriorates the performance in the MANET.

### SUMMARY OF THE INVENTION

Accordingly, the present invention has been made to solve the above-described problems occurring in the prior art, and a first object of the present invention is to provide an apparatus and a method which can perform connection to an external network while efficiently using maximum resources in a mobile terminal in a wireless environment.

A second object of the present invention is to provide an apparatus and a method for minimizing an effect on other nodes and factors by internet protocol version 6 (IPv6) address change of a node in a mobile ad-hoc (MANET) network for connection of the MANET network with the Internet.

A third object of the present invention is to provide an apparatus and a method, in which an address for connecting to the Internet and an address used in an internal network are separately used for each node in a MANET network, so as to prevent execution of an unnecessary address change process, thereby minimizing control packets, which are overhead packets in the network.

In order to accomplish the aforementioned objects, according to one aspect of the present invention, there is provided a system for performing communication with an external network through an Internet gateway in a MANET network including more than one node having a link local address, the system including a source node for setting a source address to the link local address, and transmitting packet data, a destination address of which has been set to an address of the external network, to the Internet gateway; and the Internet gateway for changing a source address of the packet data to a global address corresponding to the link local address, and transmitting the global address to the external network, when the packet data, a destination of which is the external network, are received from the source node.

In order to accomplish the aforementioned objects, according to one aspect of the present invention, there is provided a method for performing communicating with an external network through an Internet gateway in a MANET network including more than one node, the method including the node setting a source address to a link local address, and transmitting packet data, a destination address of which has been set to an address of the external network, to the Internet gateway; and changing a source address of the packet data to a global address corresponding to the link local address, and transmitting the global address to the external network, when the packet data, a destination of which is the external network, are received from the source node.

### BRIEF DESCRIPTION OF THE DRAWINGS

The above and other objects, features and advantages of the present invention will be more apparent from the following detailed description taken in conjunction with the accompanying drawings, in which:

FIGS. 1a and 1e are block diagrams showing flow for connecting to an external network in the conventional IPv6 network; (PLEASE ADD AN INSCRIPTION “PRIOR ART”)

FIG. 2 is a flow chart showing flow of signals between a source node and an Internet gateway for connecting to an external network in the conventional IPv6 network; (PLEASE ADD AN INSCRIPTION “PRIOR ART”)

FIGS. 3a to 3c are block diagrams showing flow of signals for connecting to an external network in an IPv6 network according to an embodiment of the present invention;

FIGS. 4a and 4b are block diagrams showing structure of each packet used for communication in an internal network and communication with an external network according to an embodiment of the present invention;

FIG. 5 is a flowchart illustrating a method according to an embodiment of the present invention, which allows an Internet gateway to interconnect communication between a node and an external network in an internet protocol version 6 (IPv6) network; and

FIG. 6 is a flowchart illustrating a method according to an embodiment of the present invention, which allows an Internet gateway to transceive data between an external network and a source node.

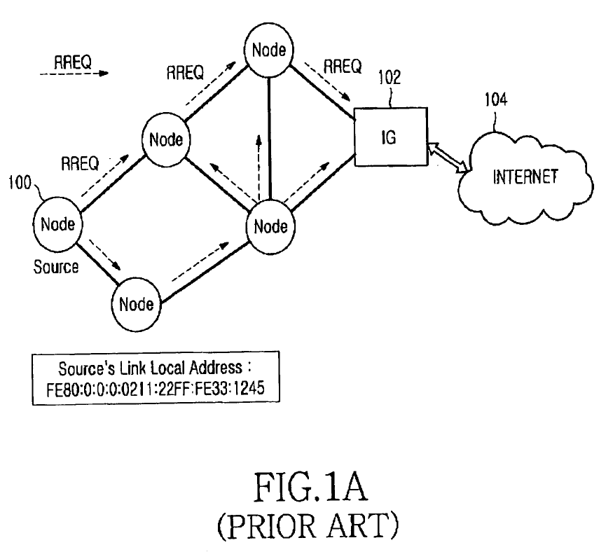

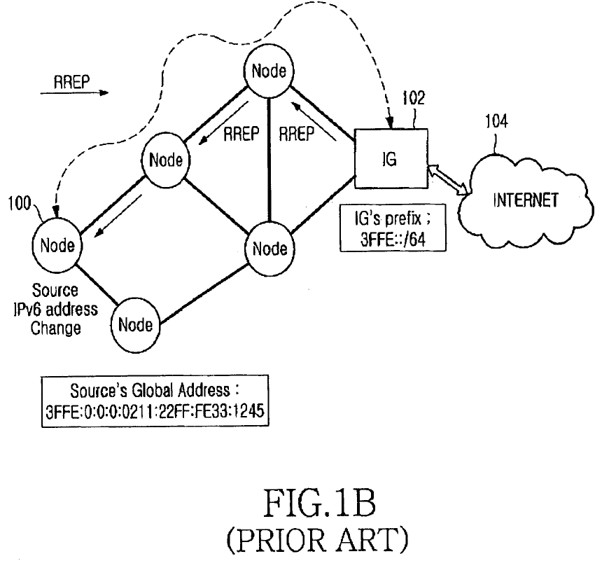

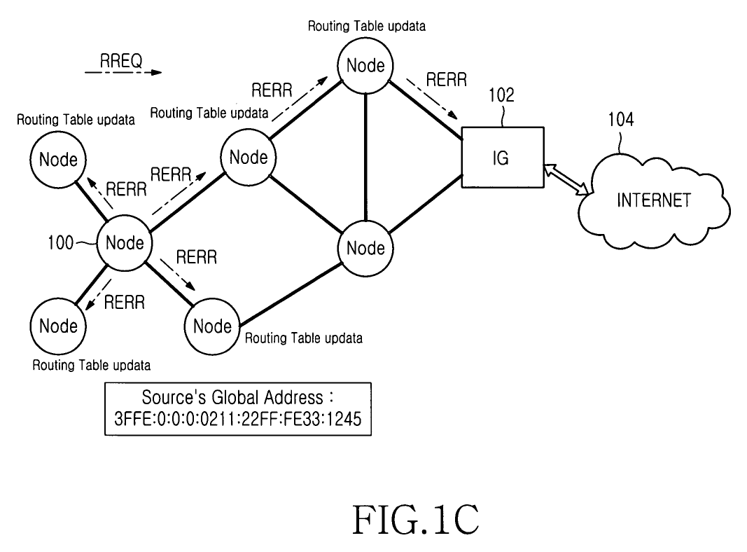

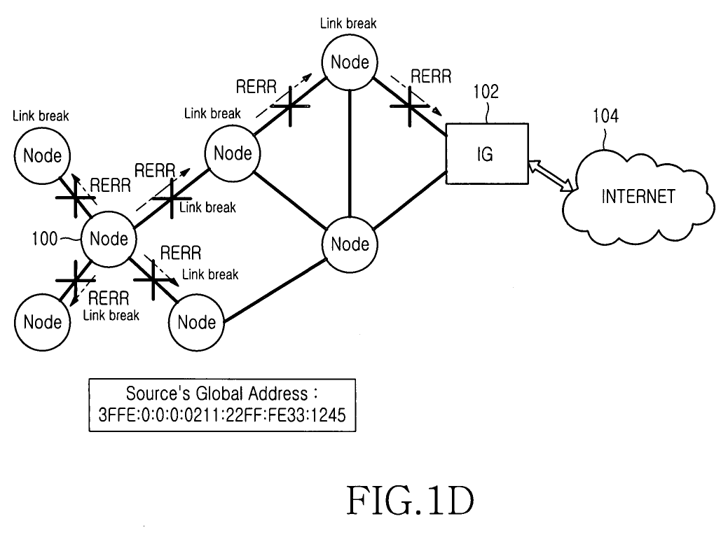

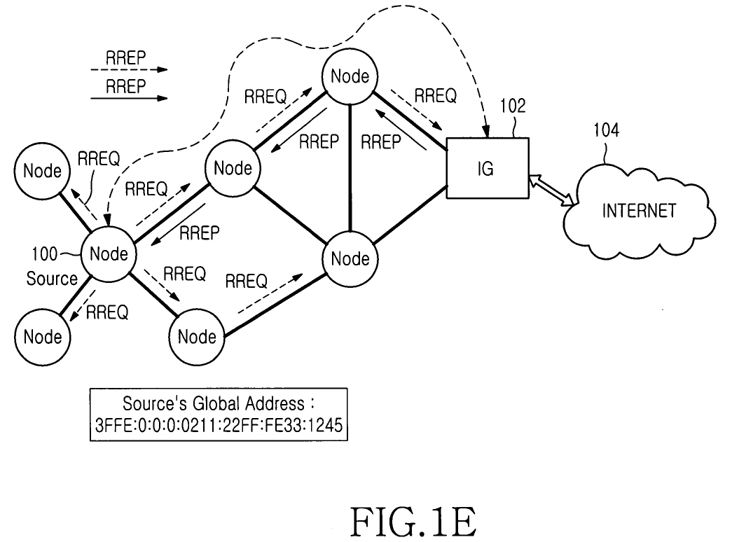

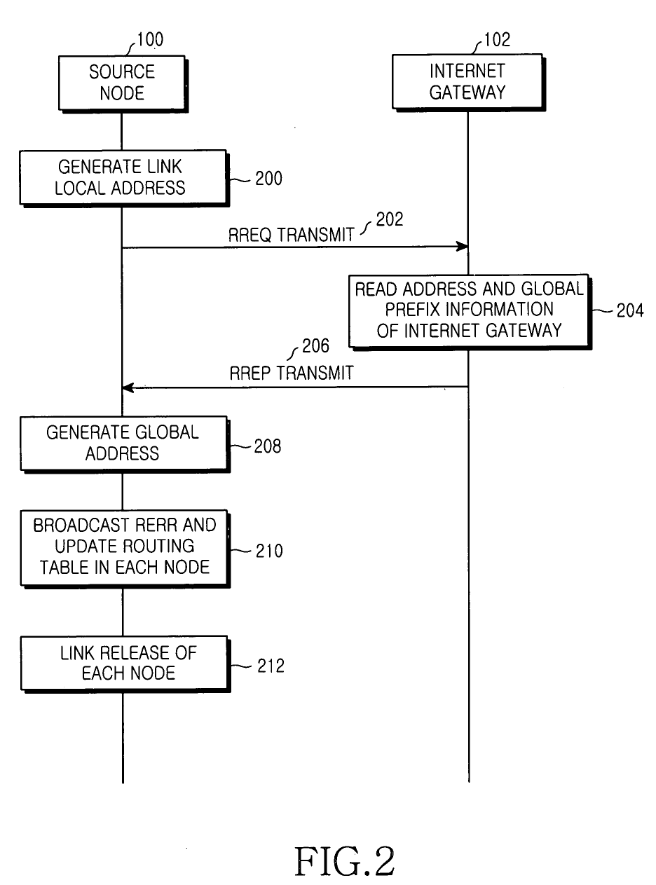

### DETAILED DESCRIPTION OF THE PREFERRED EMBODIMENT

Hereinafter, a preferred embodiment according to the present invention will be described with reference to the accompanying drawings. In the following description of the present invention, a detailed description of known functions and configuration incorporated herein will be omitted when it may make the subject matter of the present invention unclear.

According to the present invention, in an Internet protocol version 6 (IPv6)-based mobile ad-hoc (MANET) network, a link local address is used when communication is performed in an internal network, and a global address is used only when there is a connection to an exterior, that is, the connection to the exterior is performed through an Internet gateway, so that communication can be performed in the internal network even without recognizing the global address.

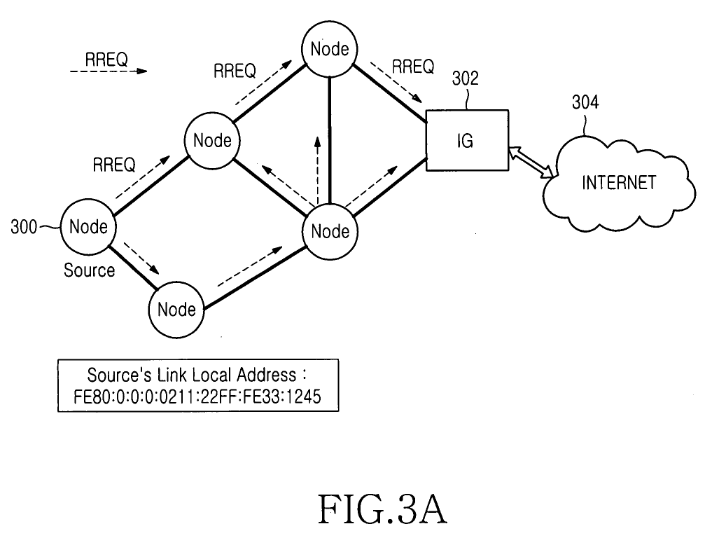

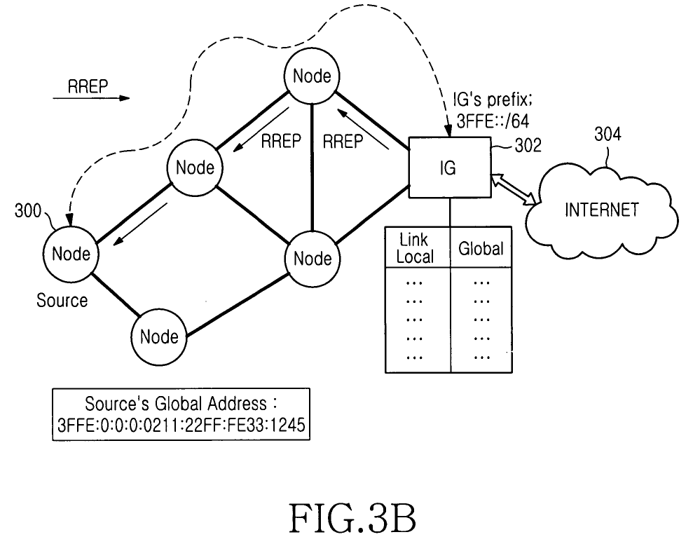

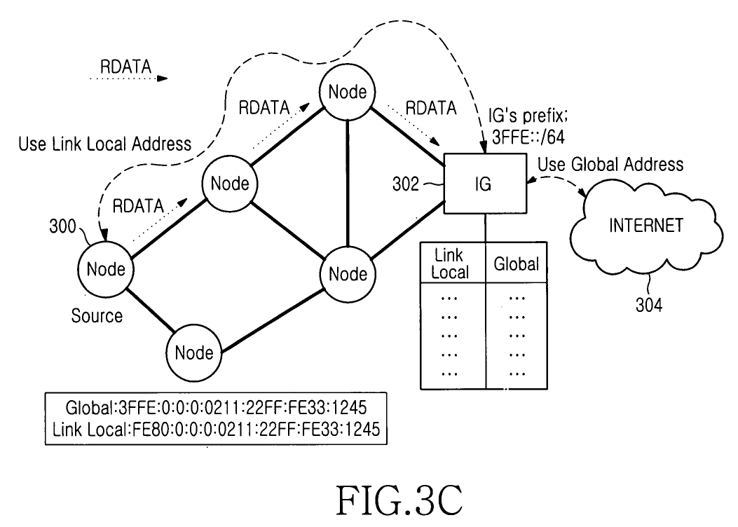

Hereinafter, a process in which a node is connected to the Internet, which is an external network, will be described with reference to FIGS. 3a to 3c. FIGS. 3a to 3c show flow of signals for connecting to an external network in an IPv6 network according to an embodiment of the present invention.

First, referring to FIG. 3a, a source node 300 transmits a RREQ to an Internet gateway 302 through nodes. Herein, the RREQ is used when the source node 300 requests prefix information of the Internet gateway 302 for generating a global address in order to be connected to the Internet. Then, the Internet gateway 302 transmits a RREP to the source node 300 having transmitted the RREQ as shown in FIG. 3b. Herein, the transmitted RREP is a message including the prefix information of the Internet gateway 302 as a response of the RREQ. Further, the Internet gateway 302 stores the global address, which corresponds to the link local address of the node having transmitted the RREQ, in an address management table. That is, the Internet gateway 302 includes the address management table in order to perform the present invention. Therefore, when data are transmitted from the Internet 304 to a corresponding source node 300 by means of the global address, the Internet gateway 302 receives the data and transmits the received data to the source node 300 having the link local address corresponding to the global address. Accordingly, as shown in FIG. 3c, the global address is used for communication between the Internet gateway 302 and the Internet 304. Further, the link local address is used in an internal network including the Internet gateway 302, intermediate nodes, and the source node 300.

In the present invention as described above, only the link local address is used when a route is formed in an internal MANET network. In contrast, only when the connection to the external network is required, a route formation is requested to the Internet gateway, the RREP is received from the Internet gateway, and the global address is generated. Herein, even if the global address has been generated, the global address is not used even in the internal MANET network. Instead, the link local address is continuously used in the internal MANET network to form the route. Further, only when the node requests connection to an exterior, the Internet gateway interfaces and forms connection to the external network. When the node to be connected to the external network is connected to the external network, the link local address contained in a header of an IP packet transmitted by the node changes to the global address and is used in generating an IP header. However, the link local address is used as an address contained in a MANET header of an IP packet for communication in the internal MANET network.

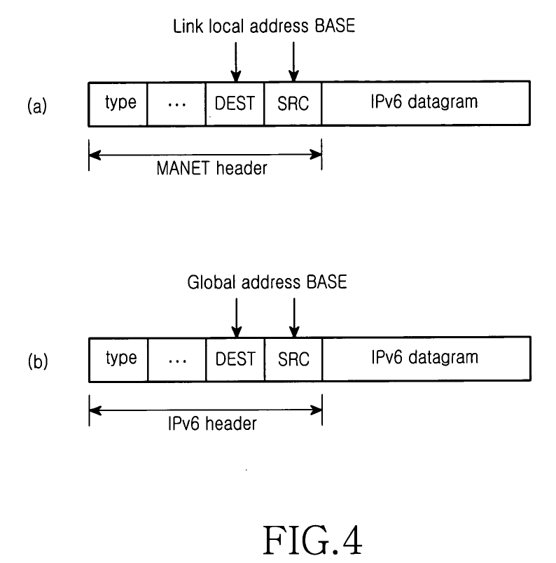

Hereinafter, structure of IP packets for communication in the internal network and communication with the external network will be described with reference to FIGS. 4a and 4b. FIGS. 4a and 4b show structure of each packet used for communication in the internal network and communication with the external network according to an embodiment of the present invention. First, referring to FIG. 4a, in the MANET header of the IP packet for communication in the MANET network, a source address (SRC), an address of the source node, is formed on the basis of the link local address. Further, referring to FIG. 4b, in an IPv6 header for communication with the Internet, the source address (SRC) of the source node is formed on the basis of the global address.

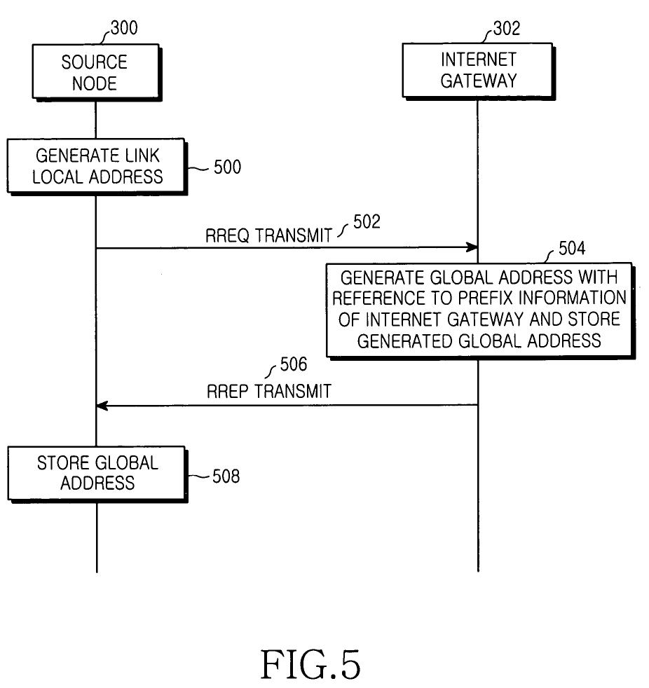

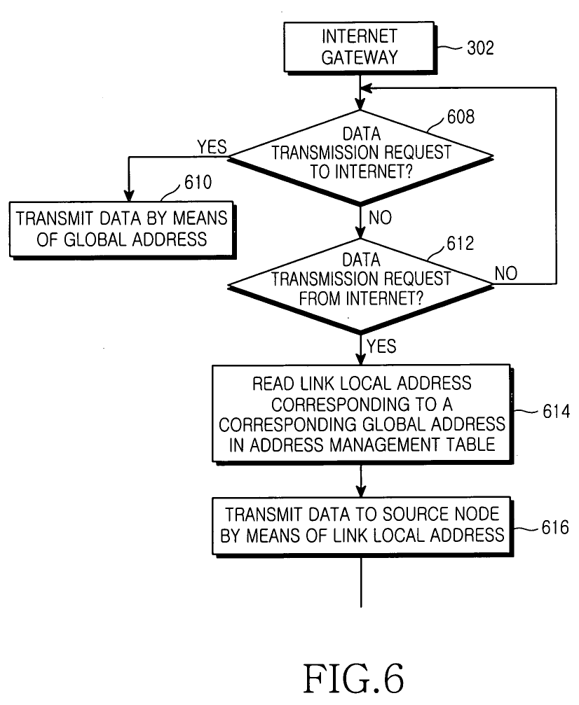

Hereinafter, processes in which the address of the source node for communication with the Internet 304 and the address of the source node for communication in the internal network are used will be described with reference to FIGS. 5 and 6. Further, the use of the address in the present invention means that a source address of packet data is set to the link local address and communication is performed, or the source address of the packet data is set to the global address and communication is performed.

FIG. 5 is a flowchart illustrating a method according to an embodiment of the present invention, which allows the Internet gateway to interconnect communication between the node in the MANET network including more than one node and the external network.

First, the source node 300 generates the link local address for communication paths between nodes in the internal network in step 500, and then in step 502, transmits the RREQ to the Internet gateway 302 in order to communicate with the Internet 304 through the Internet gateway 302. The Internet gateway 302 having received the RREQ updates, in step 502, the link local address of the node, which has transmitted the RREQ, in the address management table, and stores the link local address of the node correspondingly to a global address. Then, the Internet gateway 302 transmits the RREP to the source node 300 in step 506. Herein, the transmitted RREP is a message including the prefix information of the Internet gateway 302 as a response of the RREQ. The source node 300 having received the RREP generates the global address. Then, the source node 300 can perform communication with the Internet 304 by means of the generated global address.

Hereinafter, a process in which communication in the internal network and communication with the external network are performed by means of the link local address and the global address generated as described in FIG. 5 will be described with reference to FIG. 6. FIG. 6 is a flowchart illustrating a method according to an embodiment of the present invention, which allows the Internet gateway for transceiving data between the external network and the source node.

First, the source node 300 uses the link local address for communication between nodes in the internal network. Referring to FIG. 6, when it is determined in step 608 that there exists a data transmission request from the source node 300 to the Internet 304, in step 610 the Internet gateway 302 transmits data to the corresponding Internet by means of the global address. Otherwise, in step 612, it is determined whether there exists a data transmission request from the Internet 304 to the source node 300. In the affirmative, the Internet gateway 302 reads the link address of the source node 300, which corresponds to a corresponding global address, from the address management table in step 614. Then, the Internet gateway 302 transmits the data to the source node 300 by means of the link local address in step 616. If both determinations are negative, the process returns to step 608.

That is, when the source node 300 transmits packet data to the Internet 304, the link local address is used for a route path from the source node 300 to the Internet gateway 302, and the global address is used for a route path from the Internet gateway 302 to the Internet 304. Hereinafter, a case in which the source node 300 receives packet data from the Internet 304 will be described. In a header of an IP packet transmitted from the Internet 304 to the Internet gateway 302, a destination is expressed by the global address. The Internet gateway 302 having received the IP packet generates a MANET header in order to transmit the packet to the MANET network, and includes the MANET header into the header of the IP packet. Herein, when a destination address in the IP header is contained in the address management table of the Internet gateway 302, it means that the Internet gateway 302 has a route path for the node the MANET network. Accordingly, when generating the MANET header, the Internet gateway 302 reads the link local address, which corresponds to the destination global address, with reference to the address management table. Then, the Internet gateway 302 inputs a corresponding local address as a destination address value of the MANET header, and generates MANET packet data to transmit the generated data. Since every node in the MANET network forms a router on the basis of the link local address, the MANET packet data generated as described above can be smoothly transceived in the internal network.

According to the present invention as described above, in an IPv6-based MANET network, a link local address is used when communication between nodes is performed in an internal MANET network, and a global address is used only when there is a connection to an external network, that is, the connection to the external network is performed through an Internet gateway. Therefore, communication can be performed in the internal network even without recognizing the global address.

According to the present invention as described above, in an IPv6-based MANET network, a link local address is used when communication is performed in an internal network, and a global address is used only when there is a connection to an external network. That is, the connection to the external network is performed through an Internet gateway. Therefore, communication can be performed in the internal network even without recognizing the global address. Accordingly, overload is removed from the existing link local address to a global address, overload on peripheral nodes in changing routing tables is reduced, resources for a node are economized, and a flow of control packets is reduced in the address change, so that overload on the network can be reduced. Therefore, the MANET network can be efficiently constructed, in which each node can perform communication.

While the invention has been shown and described with reference to certain preferred embodiments thereof, it will be understood by those skilled in the art that various changes in form and details may be made therein without departing from the spirit and scope of the invention as defined by the appended claims.

1. A system for communicating with an external network through an Internet gateway in a mobile ad-hoc (MANET) network including more than one node having a link local address, the system comprising:
a source node for
setting a source address to the link local address, and
transmitting packet data to the Internet gateway, a destination address of the packet data having been set to an address of the external network; and
the Internet gateway for
changing a source address of the packet data to a global address corresponding to the link local address, and
transmitting the packet data to the global address of the external network, when the packet data with destination of the external network is received from the source node.

2. The system as claimed in claim 1, wherein the source node
generates the link local address for communication in the MANET network,
requests prefix information of the Internet gateway for communication with the external network,
receives the prefix information from the Internet gateway, and
generates the global address.

3. The system as claimed in claim 1, wherein the Internet gateway generates the global address of the source node, and stores the global address in a management table correspondingly to the link local address when a request for prefix information is received from the source node.

4. The system as claimed in claim 1, wherein the Internet gateway transmits the data to the source node by means of the link local address corresponding to the global address of the source node in a management table when there exists a data transmission request from the external network to the source node.

5. A method of communicating with an external network through an Internet gateway in a mobile ad-hoc (MANET) network including more than one node, the method comprising the steps of:
a node setting a source address to a link local address, and transmitting packet data having a destination address set to an address of the external network, to the Internet gateway; and
changing a source address of the packet data to a global address corresponding to the link local address, and transmitting the global address to the external network when the packet data with destination of the external network is received from the source node.

6. The method as claimed in claim 5, further comprising the steps of:
changing a global address of the node to the link local address; and
transmitting the data to the node, in response to a data transmission request from the external network to the node.

7. A method for allowing an Internet gateway to communicate between a node in a mobile ad-hoc (MANET) network and an external network, the MANET network including more than one node, the method comprising the steps of:
generating a global address of the node and when a request for prefix information is received from the node storing the global address in a management table corresponding to a link local address of the node; and
transmitting the prefix information to the node.
